(19) United States
(12) Patent Application Publication
(10) Pub. No.: US 2012/0006052 A1
(43) Pub. Date: Jan. 12, 2012

(54) Windmill driven, ocean floating atmospheric CO2 removal system

(76) Inventor: Charles K. Brown, JR., Richmond, VA (US)

(21) Appl. No.: 12/803,813

(22) Filed: Jul. 7, 2010

(51) Int. Cl. F25J 1/00; F03D 9/00

(52) U.S. Cl. 62/602; 290/55

(57) ABSTRACT

A multi-stage pumping system that can take liquid CO₂, that has been extracted from the air by a new technology called “Tree”, chill and compress it into a torpedo shaped chamber to form a slug of dry ice. The slug is then ejected to be sequestered at the bottom of the oceans. The deep ocean surrounds the CO₂ dry ice with so much pressure that sublimation cannot occur and the dry ice remains solid for eons of time. This CO₂ will not contribute to global warming. Nor will it dissolve into the ocean.

As a background note, the World has entered a period of global warming caused by the industrial world dumping unusual amounts of CO₂ into the atmosphere. Carbon dioxide results from burning hydrocarbon fuels like coal, oil and natural gas. The purpose of this invention is to provide an efficient means of sequestering atmospheric CO₂ to the bottom of the ocean.

Schematic drawings seen on sheets 1 thru 6 show schematic construction of the CO₂ removal and sequestering system and are the visual aids to describing the process of removing CO₂ from the air we breath, forming it into dry ice and sequestering it at the bottom of the oceans in depths that prohibit it from sublimating back to gaseous state and dissolving in the ocean or returning back up to the atmosphere.

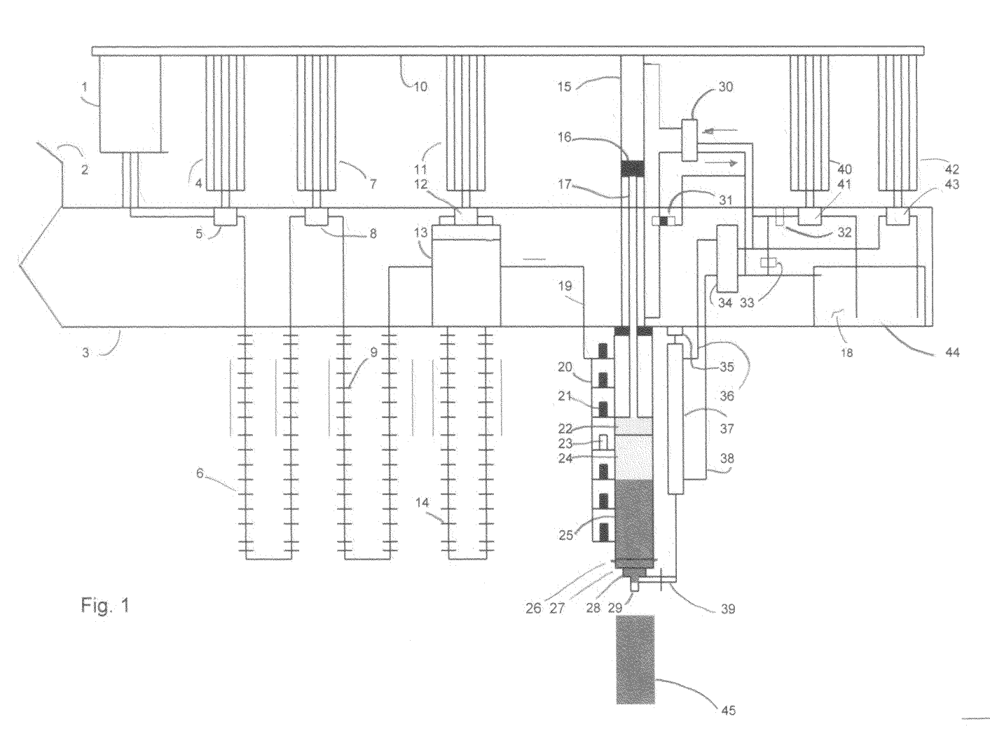

FIG. 1 on Sheet 1/6 schematic shows all the floating elements that make up one unit of the thousands that will make up the whole system.
1. Air CO₂ capturing technology
2. Ocean wave deflecting shields
3. Floating barge that supports all of the CO2 capturing and sequestering system.
4. Wind mill to drive first stage CO₂ pump
5. CO₂ pressurizing pump, first stage
6. Fin cooling section on CO₂ pipe line from first stage to second stage CO₂ pumps
7. Wind mill to drive second stage CO₂ pump
8. CO₂ pressurizing pump, second stage
9. Fin cooling section on CO₂ pipe line from second stage pump to CO₂ chiller unit
10. Strut structure to tie and brace Air CO₂ capturing technology, the windmills and the hydraulic cylinder together to help resist extremely high winds
11. Refrigerator-Chilling unit pump windmill drive
12. Refrigerator-Chilling unit pump
13. Refrigerator-Chilling unit
14. Fined pipe cooling section for the chilling unit
15. Hydraulic cylinder to ram and compact CO2 flakes in column chamber
16. Hydraulic cylinder piston
17. Interconnecting piston rod
18. Hydraulic oil
19. Liquid CO₂ conduit from chiller to valve manifold
20. Liquid CO2 control valve manifold
21. Closed valves
22. Dry ice snow compaction piston which is porous to allow gas to escape but retains the snow flakes of CO₂ to be pressed into solid dry ice
23. Open valve charging dry ice formation chamber column
24. CO₂ snow flakes formation and compaction zone
25 Dry ice formation chamber column
26. Dry ice formation chamber column end closure cap lock ring
27. Formed and compacted dry ice zone
28. Dry ice formation chamber column end closure cap
29. Water purging pressure relief valve
30. Hydraulic cylinder control valve for controlling the up and down movement of the hydraulic piston 16 driving the CO2 snow compacting piston 22.
31. Three way valve controls relief of back pressure in high pressure phase
32. and 33. Two valves that work in synchrony to bypass fluid back to the tank from the low pressure, high volume pump, 32 closes and 33 opens.
34. Hydraulic valve for controlling the hydraulic cylinder that operates the end cap sealing mechanism
35 Anchorage for base end of the hydraulic cylinder that opens and closes the dry ice formation chamber column sealing cap.
36. Hydraulic closing line for sealing end cap
37. Dry ice formation chamber column, sealing cap operating hydraulic cylinder
38. Hydraulic opening line for sealing end cap
39. Lever arm to support sealing end cap
40. Low pressure, high volume Hydraulic pump windmill drive
41. Low pressure, high volume Hydraulic pump
42. High pressure, low volume Hydraulic pump windmill drive
43. High pressure, low volume Hydraulic pump
44. Hydraulic tank
45. Dry ice slug

Looking at FIG. 1 on Sheet 1/6 a multi-stage pumping system is shown to take liquid CO2 that has been extracted from the air, by a new technology called “Tree” 1. Then chill and compress it into a dry ice slug and then eject it to be sequestered at the bottom of the oceans in the form of dry ice. The deep ocean surrounds the CO2 dry ice with so much pressure that sublimation cannot occur and the dry ice remains solid for eons of time. This CO2 will not contribute to global warming. Nor will it dissolve into the ocean.

This newly developed CO2 capturing technology called “Tree” is very efficient at removing CO2 from the air as a virtually pure gas. The gas has to be sequestered safely away. What my invention does is improve over conventional sequestering means by doing it in a more efficient and secure way. VP Al Gore states in his book “OUR CHOICE” that it would take all the power of one power plant to sequester underground all the CO2 from it and three other power plants.

Since the CO2 is being sequestered into the oceans with my process it only makes sense to do the work out on the oceans. A great amount of free wind power is available which makes the process acceptable economically. The drawing FIG. 1 on sheet 1/6 represents a single unit in an island of thousands of floating units that is comprised of the above listed elements.

FIG. 1. on Sheet 1/6 is a schematic linear view 0f the working equipment. It is visualized that all of the equipment will be installed on what is essentially a barge like structure that will be roughly 50′×50′×6′ deep. thousands of these barges 3 will be fastened together to make large floating islands that can be anchored around the world at strategic spots.

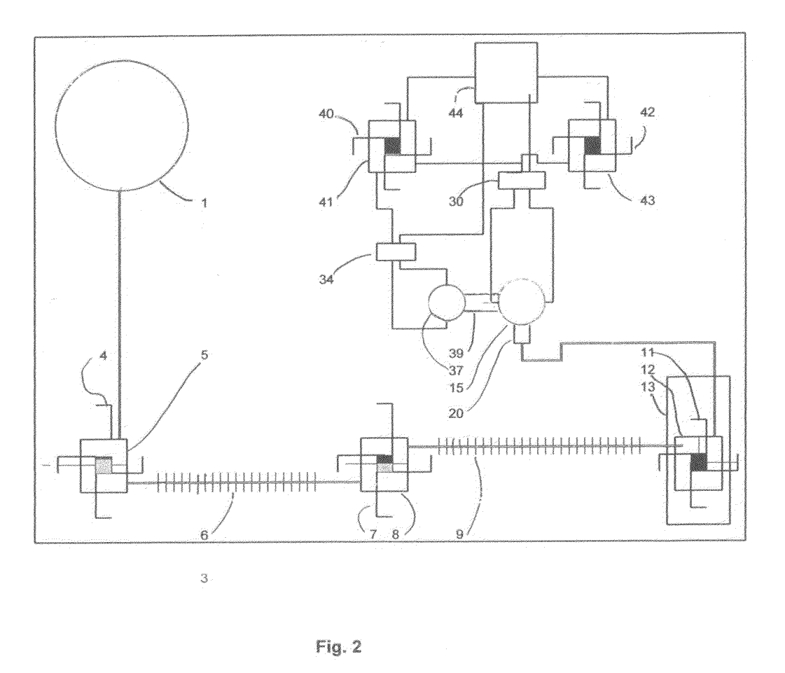

FIG. 2 on Sheet 2/6 is a schematic plan view of sheet 1/6 showing the basic unit of a multi-unit floating island. The plan is to launch as many as 30,000 units in 5,000 unit islands around the world in strategic locations.

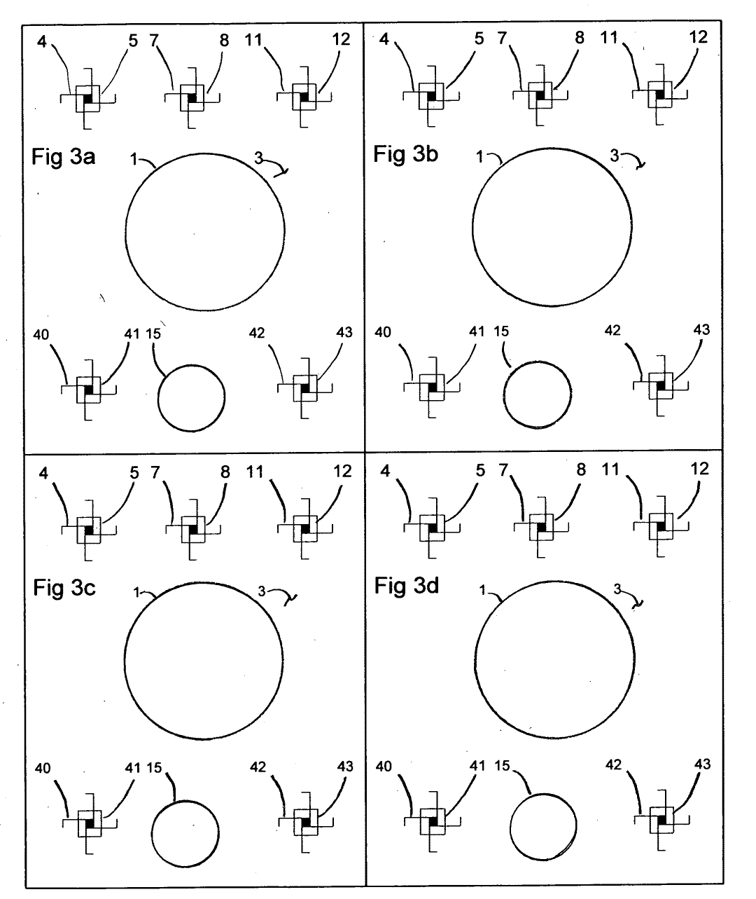

FIG. 3 on Sheet 3/6 is a schematic plan view of the basic unit seen on Sheet 2/6 starting to be clustered into islands as elucidated on before.

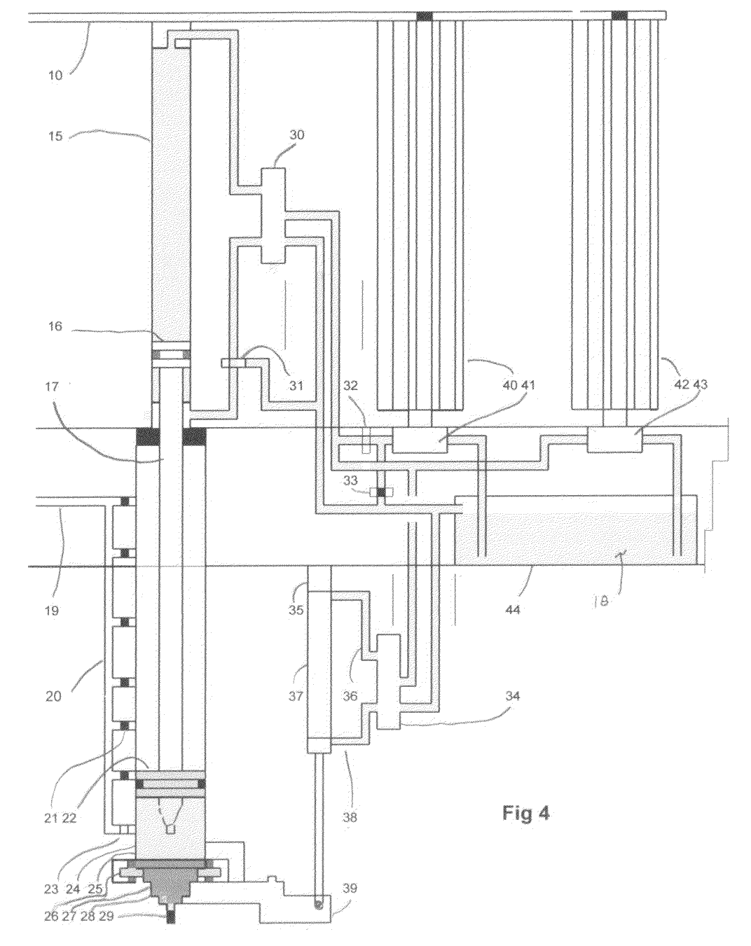

FIG. 4 on Sheet 4/6 is a schematic elevation of the first stage of the process of compacting the liquid CO2 into chamber 26. The first layers of dry ice are shown just filling end seal cap 28. Open valve 23 is injecting liquid CO2 into the open space shown where it forms snow that is compacted into dry ice under pressure of piston 22 on its next down stoke. FIG. 4 on Sheet 4/6 also shows the windmill, pump and hydraulic apparatus that drives the dry ice compacting piston 22.

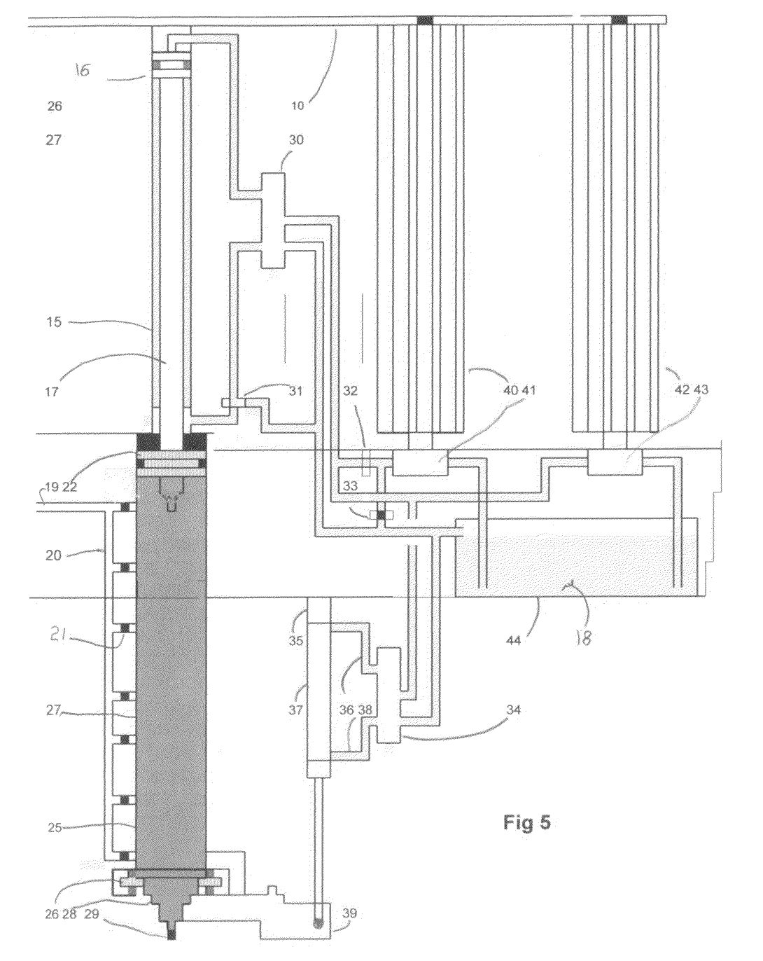

FIG. 5. On Sheet 5/6 shows the CO2 dry ice completely filling the chamber column after many cycles of raising and lowering piston 22, injecting CO2 and compressing the CO2 flakes that form in the chamber 26 into layer after layer of solid dry ice.

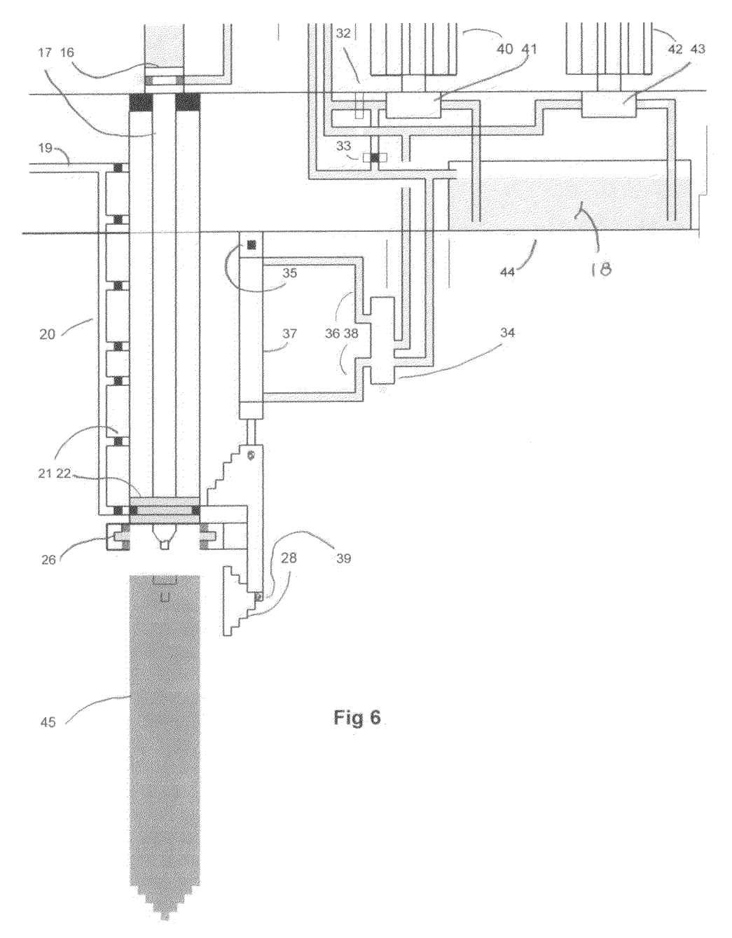

FIG. 6 on Sheet 6/6 shows the completed dry ice slug 43 ejected and on its way to the bottom of the ocean.

The process of sequestering CO2 in the ocean is set forth as follows:
1, Extract CO2 from the air using the “Tree” 1 technology.
2. Liquify the extracted CO2 with pressure and cooling.
3, Chill and Inject the pressurized liquid CO2 into sealed chamber column 26. CO2 snow flakes form in the sealed column 26 as the liquid CO2 expands in the open space under piston 22. Chilling is accomplished by using conventional refrigerating means. The liquid CO2 is chilled to less than −110 degrees F. or low enough for dry ice to be formed. There is a workable balance between low temperature and high pressure that should be found, cost wise.
4. Compress the CO2 snowflakes within the chamber column 26 with pressure sufficient to solidify the CO2 snowflakes into dry ice at a density close to 98 lbs per cubic foot It has to be heavier than water so it will sink. The heavier the slug of dry ice the faster it will sink which is good because less sublimation will occur on the way down to the bottom where the water pressure is so great that sublimation can not occur.
5. The cycle of injecting and compressing to form dry ice layer by layer continues until the whole dry ice production chamber column 26 is fully charged. See FIG. 5.
6. Hydraulically operated end cap 28 is fully opened as seen in sheet 6/6 FIG. 6 and the completed slug 45 of dry ice is forcibly ejected to the bottom of the ocean.
7. This is the final step in the operation to form a dry ice mass and sequester it away. Lock ring 26 opens so that hydraulic cylinder 37 can retract and pull open the end closure cap 28. This allows the completed slug of dry ice 45 to be forcibly ejected by pressurizing the hydraulic cylinder 15 with both the high volume pump 41 and low volume pump 43. At the end of the stroke the torpedo shaped dry ice slug 45 is moving very fast and will continue on to the bottom without sublimating very much on the way down.

Step 4 is accomplished with the CO2 snow piston 22 being rammed downward by interconnecting piston rod 17, driven by hydraulic piston 16 in hydraulic cylinder 15. A windmill 40 drives low pressure high volume pump 41 is used in closing up the open space between snow flakes. Then the high pressure, low volume pump 41 continues adding pressure on the snow flake body until it is compacted to the desired density. Repeated short up and down strokes can act like a jackhammer to achieve higher densities

The Injection control valves 21 and 23 on the valve manifold 20 are opened sequentially as the chamber column 26 fills up step by step. Valves 21 are shown as closed and 23 identifies the open valve. The valves are opened and closed sequentially by program controller or computer.

The next dry ice slug formation cycle now starts. The cycles continue automatically without interruption, except for scheduled maintenance or break down. The overall cycle operation sequence is controlled with either a programmed controller or with a computer.

An operating unit needs several windmill driven pump assemblies to perform the necessary operations. A refrigerating unit 13 is provided to deeply chill the liquid CO2. See sheet 1/6 FIGS. 1 and 2/6 FIG. 2.

By using a refrigeration process to drop the temperature of the liquid CO2 low enough to solidify into dry ice under high pressure the waste of extracted CO2 for chilling can be avoided. In conventional dry ice production about half of the liquid CO2 is flashed off to drop the temperature low enough for dry ice to form. However, the main object of this invention is about how to get rid of CO2 dry ice, not how it gets formed into dry ice. It can't be sequestered if is not made, so I am showing a means of some sort for making dry ice. Making has to be shown so the means for sequestering it can be shown. I'm not inventing the making of dry ice or making claims to that. I am just showing a possible way so I can show a way to sequester it, no matter how it is made

How all of the elements are brought together and function to produce dry ice and jettison it the bottom of the ocean is illustrated on sheets 1/6 to 6/6 and further described as follows:

Sheet 1/6 illustrates the combination of elements used to solidify liquid CO2 into dry ice and eject it out for settlement to the ocean bottom. It can have a density of up to 98 lbs per cubic foot, heavy enough to sink rapidly through sea water which weighs only about 63 lbs per cubic foot.

At the beginning of operation the column is set up as seen in Sheet 4/6 FIG. 4 with spear point bottom seal 28 in place to seal the bottom. The CO2 piston 20 set high enough to create an operating cavity large enough to receive a charge of liquid CO2 of such volume that it can be compressed sufficiently to form dry ice. If it is too large it may be difficult to compress the CO2 snow flakes enough to form high density dry ice. The plan is to build sequential layers of dry ice sufficient to fill the whole chamber 26 and then eject the completed slug 45 as previously described.

The end cap seal 28 is opened and the dry ice slug is ejected. Before the end cap 28 closes a certain amount of ocean water rushes in. After closing and sealing the water is purged by pulsing piston 16 down with enough force to open purging pressure relief valve 29 and eject the water.

As the hydraulic piston 16 raises it raises the CO2 snowflake piston 22. They, are linked together with piston rod 17.

The Co2 snow that forms when Liquid CO2 is injected into chamber 25 and the solid dry-ice that is formed by compacting the snow is differentiated between on the drawing showing the snow in light texture and the compacted dry-ice in heavier texture.

The CO2 snow compaction piston has very fine holes arranged in parallel and very close together to vent any small amount of CO2 gas on each compaction stroke. They are represented on the drawing as vertical parallel lines closely spaced.

The size and horse power of the wind turbines should be as large as possible, considering all aspects of the process, to take as much CO2 out of the atmosphere as rapidly as feasible. However, size considerations do not determine basic workability of the process. Size does effect logistic and economic factors

What is claimed is:

1. An ocean floating windmill powered CO2 sequestering system that has means to separate out atmospheric CO2, means to form it into a dry ice torpedo shaped slug within a sealed chamber that can be opened at the bottom end and the capability of ejecting said torpedo of dry ice to the bottom of the sea or ocean

2. An ocean floating, CO sub 2 extraction system, that uses a windmill powered, pumping system to transform the CO sub 2 into solid dry ice and sequester it at the bottom of the ocean so deep that it can't sublimate away into the ocean water

3. An ocean floating, CO sub 2 extraction system, that uses a windmill powered, compressing system to transform the CO sub 2 into solid dry ice and sequester it at the bottom of the ocean so deep that it can't sublimate away into the ocean water

4. An ocean floating windmill powered, pumping system that removes CO2 from the atmosphere with a new process called “Tree”, liquefies the CO2, transforms the liquid CO2 into solid dry ice and sequesters the dry ice to the bottom of the ocean so deep that it can't sublimate away into the ocean water

5. An ocean floating windmill powered pumping system that removes CO2 from the atmosphere, liquefies it, cools it by a refrigeration process, injects it into a closed chamber where CO sub 2 snow crystals form which are then compressed to form the CO2 snow flakes into a solid dry ice torpedo which is ejected to be sequestered at the bottom of the ocean, so deep that it can't sublimate away into the ocean water

6. An ocean floating windmill powered pumping system that removes CO2 from the atmosphere, liquefies it, further compresses it and cools it by a refrigeration process, transforms it into solid dry ice and sequesters it at the bottom of the ocean so deep that it can't sublimate or dissolve away into the ocean water

7. An apparatus as seen in claim 3 wherein the CO2 snowflake compressing is done by a two stage pumping system comprised of a wind turbine powered low pressure high volume hydraulic pump and a wind turbine powered high pressure low volume hydraulic pump

8. Where all of the power for this process as claimed above is generated by windmill driven electric generators and all of the pumping is done with electric motor driven pumps

9. An ocean or deep sea floating windmill powered pumping system that separates a high percentage of CO2 from the atmosphere by chemical process, compresses and cools the CO2 enriched air, transforming the. CO2 to solid dry ice and sequesters it at the bottom of the ocean so deep that it can't sublimate away into the ocean water.
